(19) United States
(12) Patent Application Publication
(10) Pub. No.: US 2020/0112426 A1
(43) Pub. Date: Apr. 9, 2020

(54) METHODS AND SYSTEMS FOR SECURE COMMUNICATIONS USING SYNCHRONIZED POLARIZED LIGHT TRANSMISSIONS AND STREAM ENCRYPTION

(71) Applicant: Vermont Secure Computing Inc., Woodstock, VT (US)

(72) Inventors: Ian Spiro, Killington, VT (US); Gregg Spiro, Boxford, MA (US); Gary Jackson, Cumberland, RI (US); Thomas P. Hardjono, Winchester, MA (US)

(21) Appl. No.: 16/597,351

(22) Filed: Oct. 9, 2019

Related U.S. Application Data
(60) Provisional application No. 62/743,342, filed on Oct. 9, 2018.

(51) Int. Cl. H04L 9/06; H04B 1/02; H04B 1/06; G02F 1/01

(52) U.S. Cl. CPC H04L 9/065; G02F 1/0136; H04B 1/06; H04B 1/02

(57) ABSTRACT

A system for secure communications between computer devices includes a transmitter device and a receiver device that can communicate in a synchronized manner using unidirectional polarized light, where any physical interference in the light transmissions results in the termination of the communications channel. The system utilizes stream encryption in the transmitter device and the receiver device to encrypt the data payload being communicated.

### CROSS REFERENCE TO RELATED APPLICATION

This application claims priority from U.S. Provisional Patent Application No. 62/743,342 filed on Oct. 9, 2018 entitled METHODS AND SYSTEMS FOR SECURE COMMUNICATIONS USING SYNCHRONIZED POLARIZED LIGHT TRANSMISSIONS AND STREAM ENCRYPTION, which is hereby incorporated by reference.

### BACKGROUND

The present application relates to methods and systems for secure communications between computer devices.

### BRIEF SUMMARY OF THE DISCLOSURE

A computer-implemented method for communicating information from a transmitter device to a receiver device in accordance with one or more embodiments includes the steps of: providing a first seed value to a first stream generator at the transmitter device and the same first seed value to a first stream generator at the receiver device; providing a second seed value to a second stream generator at the transmitter device and the same second seed value to a second stream generator at the receiver device; generating a first sequence of random numbers based on the first seed value by the first stream generator at the transmitter device and the same first sequence of random numbers based on the first seed value by the first stream generator at the receiver device; generating a second sequence of random numbers based on the second seed value by the second stream generator at the transmitter device and the same second sequence of random numbers based on the second seed value at the second stream generator at the receiver device; generating a polarization value by a polarization value generator to drive a light polarizer using the second sequence of random numbers in the transmitter device, and generating a polarization value by a polarization value generator to drive a light polarizer using the second sequence of random numbers in the receiver device; receiving plaintext data at the transmitter device; encrypting the plaintext data into ciphertext using the first sequence of random numbers generated by the first stream generator; converting the ciphertext to unidirectional polarized light by the light polarizer in the transmitter device; transmitting the unidirectional polarized light from the transmitter device to the receiver device; converting the unidirectional polarized light to the ciphertext using the light polarizer in the receiver device; decrypting the ciphertext using the first sequence of random numbers generated by the stream generator in a receiver device to recover the plaintext data; and outputting the plaintext data from the receiver device.

A communications system in accordance with one or more embodiments comprises a transmitter device and a receiver device. The transmitter device comprises: a first stream generator for generating a first sequence of random numbers based on a first seed value; a second stream generator for generating a second sequence of random numbers based on a second seed value; a light polarizer; a polarization value generator for generating a polarization value by to drive the light polarizer using the second sequence of random numbers; and a cipher for encrypting plaintext data received by the transmitter into ciphertext using the first sequence of random numbers generated by the first stream generator; wherein the light polarizer converts the ciphertext to unidirectional polarized light for transmission. The receiver device receives the unidirectional polarized light from the transmitter device. The receiver device comprises: a first stream generator for generating the first sequence of random numbers based on the first seed value; a second stream generator for generating the second sequence of random numbers based on the second seed value; a light polarizer for converting the unidirectional polarized light received from the transmitter device to the ciphertext; a polarization value generator for generating the polarization value by to drive the light polarizer in the receiver device using the second sequence of random numbers; a cipher for decrypting the ciphertext using the first sequence of random numbers generated by the stream generator in the receiver device to recover the plaintext data.

A bi-directional communications system in accordance with one or more embodiments comprises a first transmitter device, a first receiver device, a second transmitter device, and a second receiver device. The first transmitter device comprises a first stream generator for generating a first sequence of random numbers based on a first seed value; a second stream generator for generating a second sequence of random numbers based on a second seed value; a light polarizer; a polarization value generator for generating a polarization value by to drive the light polarizer using the second sequence of random numbers; and a cipher for encrypting plaintext data received by the first transmitter into ciphertext using the first sequence of random numbers generated by the first stream generator; wherein the light polarizer converts the ciphertext to unidirectional polarized light for transmission to the receiver device. The first receiver device comprises a first stream generator for generating the first sequence of random numbers based on the first seed value; a second stream generator for generating the second sequence of random numbers based on the second seed value; a light polarizer for converting the unidirectional polarized light received from the first transmitter device to the ciphertext; a polarization value generator for generating the polarization value by to drive the light polarizer in the first receiver device using the second sequence of random numbers; a cipher for decrypting the ciphertext using the first sequence of random numbers generated by the stream generator in the first receiver device to recover the plaintext data. The second transmitter device comprises a first stream generator for generating a third sequence of random numbers based on a third seed value; a second stream generator for generating a fourth sequence of random numbers based on a fourth seed value; a light polarizer; a polarization value generator for generating a polarization value by to drive the light polarizer in the second transmitter device using the fourth sequence of random numbers; and a cipher for encrypting plaintext data received by the second transmitter into ciphertext using the third sequence of random numbers generated by the first stream generator in the second transmitter; wherein the light polarizer converts the ciphertext from the cipher in the second transmitter to unidirectional polarized light for transmission. The second receiver device receives the unidirectional polarized light from the second transmitter device. The second receiver device comprises a first stream generator for generating the third sequence of random numbers based on the third seed value; a second stream generator for generating the fourth sequence of random numbers based on the fourth seed value; a light polarizer for converting the unidirectional polarized light received from the second transmitter device to the ciphertext; a polarization value generator for generating the polarization value by to drive the light polarizer in the second receiver device using the fourth sequence of random numbers; a cipher for decrypting the ciphertext using the third sequence of random numbers generated by the stream generator in the second receiver device to recover the plaintext data; wherein the first transmitter device and the second receiver device are cryptographically interlocked and form a first communications unit, and wherein the second transmitter device and the first receiver device are cryptographically interlocked and form a second communications unit.

### BRIEF DESCRIPTION OF THE DRAWINGS

FIG. 1 is a high-level view of an exemplary communications system including a Transmitter Device (TXD) and a Receiver Device (RXD) in accordance with one or more embodiments.

FIG. 2 is a high-level view of another exemplary communications system in accordance with one or more embodiments.

FIG. 3 is a simplified block diagram illustrating one example of a computer system usable in a communications system in accordance with one or more embodiments.

Like or identical reference numbers are used to identify common or similar elements.

### DETAILED DESCRIPTION

In accordance with one or more embodiments, a Transmitter device and a Receiver device can communicate in a synchronized manner using unidirectional polarized light, where any physical interference in the light transmissions results in the termination (abort) of the communications channel. The methods and systems utilize stream encryption in the Transmitter device and Receiver device to encrypt the data payload being communicated.

### Pair of Transmitter Device and Receiver Device

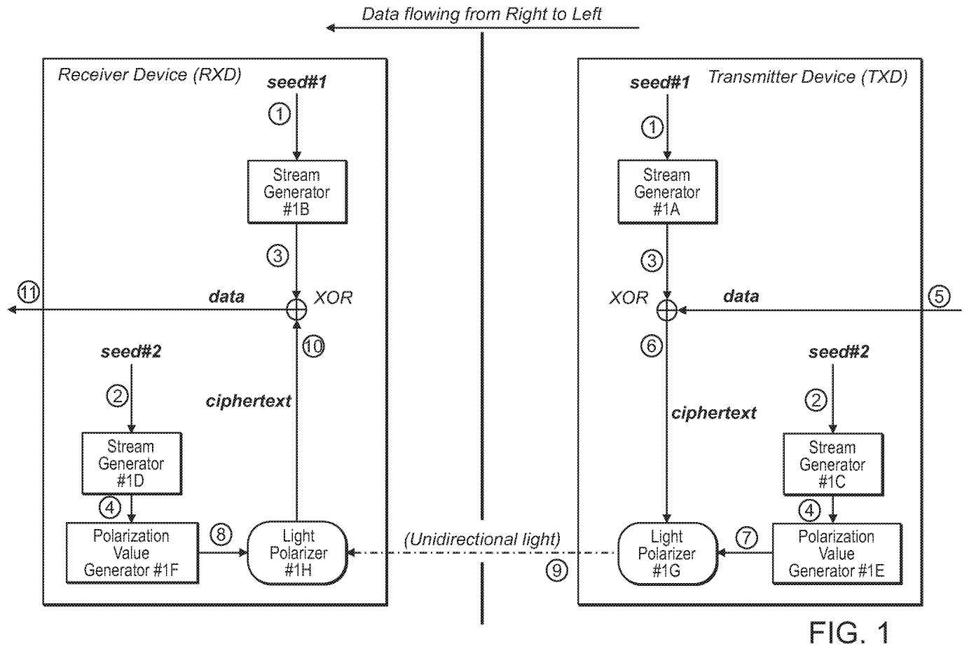

FIG. 1 is a high-level view of an exemplary communications system including a Transmitter Device (TXD) and a Receiver Device (RXD) in accordance with one or more embodiments. The transmitter device obtains plaintext data from an external source, and then sends the data to the receiver device using polarized light.

The components/parts of an exemplary system in accordance with one or more embodiments include the following:
Stream Generator (SG): The Stream Generator accepts a random Seed as input, and generates a stream of random-numbers in the manner of a stream-cipher. Generally any standard stream-cipher can be used, so long as given the same seed input it will produce the same random-stream.
   The pair of Stream Generators at the Transmitter Device (TXD) and the Receiver Device (RXD) achieve the effect of a One Time Pad (OTP) cipher.
Polarization Value Generator (PVG): The PVG takes as input the stream of random-numbers from its adjacent Stream Generator and converts the numbers into the appropriate polarization value that drives the Light Polarizer.
Light Polarizer (LP): This component enables communication using polarized light. There is a Light Polarizer at the Transmitter Device (TXD) and one at the Receiver Device (RXD).

An exemplary process for transmitting data from the TXD to the RXD in accordance with one or more embodiments is as follows. The numbered steps correspond to the circled reference numbers used in FIG. 1.

Step 1: The Stream Generators (#1A and #1B) at the Transmitter Device (TXD) and at the Receiver Device (RXD) are both provided (e.g., they may be manually configured) with the identical seed value Seed #1.

Step 2: The Stream Generator (#1C and #1D) at the Transmitter Device (TXD) and at the Receiver Device (RXD) are both provided (e.g., they may be manually configured) with the identical seed value Seed #2.

Step 3: The Stream Generators (#1A and #1B) generate the same sequence of random numbers, in lock-step fashion between the two Stream Generators. The number of bits outputted by the Stream Generators is configured according to the size of the data payload to be transmitted.

Step 4: The Stream Generators (#1C and #1D) generate the same sequence of random numbers that are inputted into the Polarization Value Generator (PVG) at the Transmitter Device (TXD) and the Receiver Device (RXD) respectively.

Step 5: Payload data is received from an external source (from outside Transmitter Device (TXD)).

Step 6: The payload data is encrypted (e.g., XORed) using the string of random numbers produced by the Stream Generator #1A, resulting in the ciphertext to be sent using the polarized light medium or communications.

Step 7/8: In the meantime, the Light Polarizer at the Transmitter Device (TXD) and the Receiver Device (RXD) have already been synchronized are ready to transmit the (ciphertext) data obtained from Step 6.

Step 9: The ciphertext from Step 6 is transmitted by the Transmitter Device (TXD) using the unidirectional polarized light.

Step 10: The ciphertext is received at the polarizer at the Receiver Device (RXD), and is decrypted (e.g., XORed) using the string of random numbers produced by the Stream Generator #1B.

Step 11: The successful decryption in Step 10 results in the recovery of the plaintext data, which is then forwarded to the destination (outside the Receiver Device (RXD)).

### Interlocking Pairs of Transmitter/Receiver Devices

In some deployments, there is a need for two separate pairs of Transmitter Devices (TXD) and Receiver Devices (RXD) to achieve bi-directional secure communications. One TXD-RXD pair is used for unidirectional secure communications in one direction, while the second TXD-RXD pair is used for unidirectional secure communications in the opposite direction.

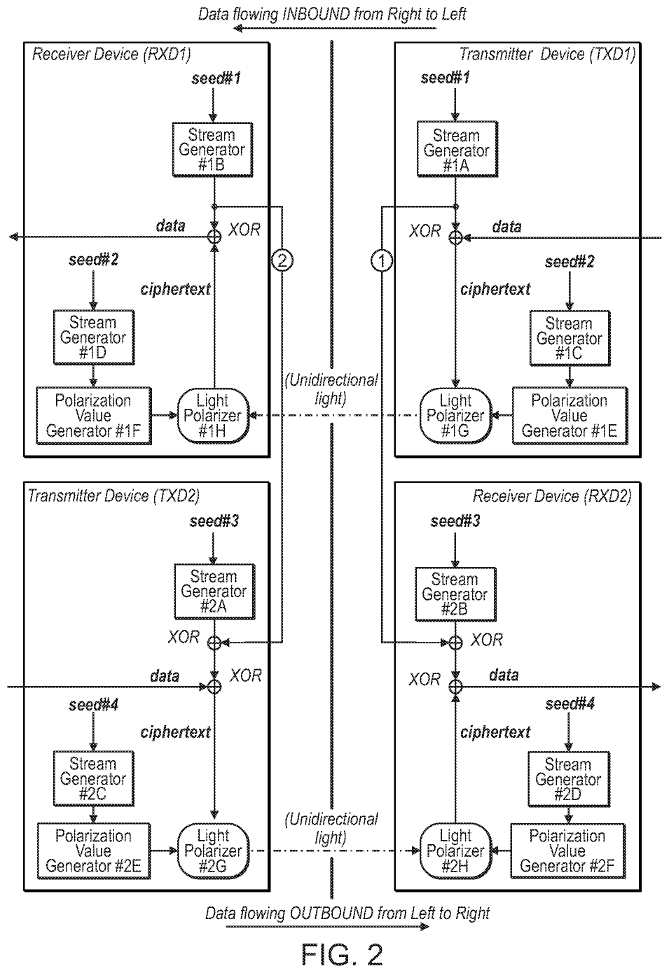

While these two pairs must operate independently in order to achieve the secure communications in their assigned direction, in deployments that require bi-directional secure communications there is a need to ensure that only the authorized physical devices (i.e., the authorized two pairs of TXD-RXD devices) are used. Furthermore, in order to detect the unauthorized removal of these two pairs of TXD-RXD devices during operations, they should be cryptographically interlocked. FIG. 2 illustrates an example of the cryptographic interlocking of the devices in accordance with one or more embodiments.

There are two parts two the interlocking mechanism shown in FIG. 2.
Connection-1: The output of the Stream Generator #1A on the Transmitter Device TXD1 is combined (e.g., XORed) into output of the Stream Generator #2B on the Receiver Device RXD2. (This is shown on right half of FIG. 2 by circled numeral 1).
Connection-2: The output of the Stream Generator #1B on the Receiver Device RXD1 is combined (e.g., XORed) into output of the Stream Generator #2A on the Transmitter Device TXD2. (This is shown on left half of FIG. 2 by circled numeral 2).

The two connections (Connection-1 and Connection-2 shown in FIG. 2) are physical connections, either through physical cables or optical cables.

### Features

Features of systems in accordance with various embodiments include:
Stream cipher to drive light polarization parameters: Using two stream ciphers (one at the Transmitter Device and another at the Receiver Device) that are manually inputted with a secret seed value and which move forward in time in a lock-step fashion, the approach allows the use of the stream cipher value (in combination with other parameters) at both polarizers to synchronize in a random fashion.
Interlocking of pairs of Transmitter Device and Receiver Devices for tamper detection: By interlocking two pairs of TXD-RXD devices, the approach allows the detection of any unauthorized removal of any Transmitter or Receiver Devices in the interlocked pairs. Should any unauthorized removal occur, the transmission through polarized light will fall out of sync and will result in the immediate termination of the secure communications between the pairs of TXD-RXD devices.

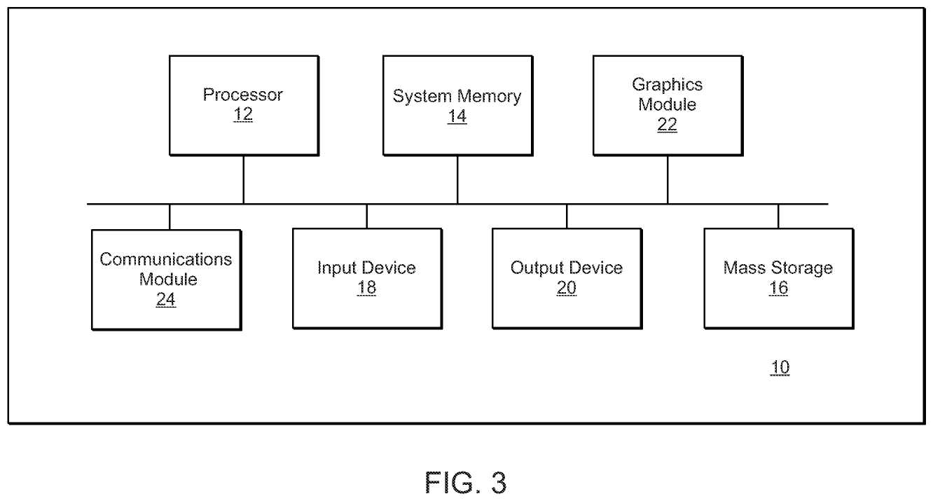

The methods, operations, modules, and systems described herein may be implemented in one or more computer programs executing on programmable computer systems. Various components of the communications systems disclosed herein may each comprise a programmable computer system. FIG. 3 is a simplified block diagram illustrating one example of a computer system 10, on which the computer programs may operate as a set of computer instructions. The computer system 10 includes at least one computer processor 12, system memory 14 (including a random-access memory and a read-only memory) readable by the processor 12. The computer system also includes a mass storage device 16 (e.g., a hard disk drive, a solid-state storage device, an optical disk device, etc.). The computer processor 12 is capable of processing instructions stored in the system memory or mass storage device. The computer system may additionally include input/output devices 18, 20 (e.g., a display, keyboard, pointer device, etc.), a graphics module 22 for generating graphical objects, and a communication module or network interface 24, which manages communication with other devices via networks.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Additionally, elements and components described herein may be further divided into additional components or joined together to form fewer components for performing the same functions. Accordingly, the foregoing description and attached drawings are by way of example only, and are not intended to be limiting.

1. A computer-implemented method for communicating information from a transmitter device to a receiver device, the method comprising the steps of:
providing a first seed value to a first stream generator at the transmitter device and the same first seed value to a first stream generator at the receiver device;
providing a second seed value to a second stream generator at the transmitter device and the same second seed value to a second stream generator at the receiver device;
generating a first sequence of random numbers based on the first seed value by the first stream generator at the transmitter device and the same first sequence of random numbers based on the first seed value by the first stream generator at the receiver device;
generating a second sequence of random numbers based on the second seed value by the second stream generator at the transmitter device and the same second sequence of random numbers based on the second seed value at the second stream generator at the receiver device;
generating a polarization value by a polarization value generator to drive a light polarizer using the second sequence of random numbers in the transmitter device, and generating a polarization value by a polarization value generator to drive a light polarizer using the second sequence of random numbers in the receiver device;
receiving plaintext data at the transmitter device;
encrypting the plaintext data into ciphertext using the first sequence of random numbers generated by the first stream generator;
converting the ciphertext to unidirectional polarized light by the light polarizer in the transmitter device;
transmitting the unidirectional polarized light from the transmitter device to the receiver device;
converting the unidirectional polarized light to the ciphertext using the light polarizer in the receiver device;
decrypting the ciphertext using the first sequence of random numbers generated by the stream generator in a receiver device to recover the plaintext data; and
outputting the plaintext data from the receiver device.

2. The method of claim 1, wherein the first sequence of random numbers is generated by the first stream generator at the transmitter device and by the first stream generator at the receiver device in lock step fashion.

3. The method of claim 1, wherein the second sequence of random numbers is generated by the second stream generator at the transmitter device and by the second stream generator at the receiver device in lock step fashion.

4. The method of claim 1, wherein the number of bits outputted by the first and second stream generators is configured according to the size of the plaintext data to be transmitted.

5. The method of claim 1, wherein the plaintext data is encrypted using an XOR function.

6. A communications system, comprising:
(a) a transmitter device comprising:
a first stream generator for generating a first sequence of random numbers based on a first seed value;
a second stream generator for generating a second sequence of random numbers based on a second seed value;
a light polarizer;
a polarization value generator for generating a polarization value by to drive the light polarizer using the second sequence of random numbers; and
a cipher for encrypting plaintext data received by the transmitter into ciphertext using the first sequence of random numbers generated by the first stream generator;
wherein the light polarizer converts the ciphertext to unidirectional polarized light for transmission; and
(b) a receiver device for receiving the unidirectional polarized light from the transmitter device comprising:
a first stream generator for generating the first sequence of random numbers based on the first seed value;
a second stream generator for generating the second sequence of random numbers based on the second seed value;
a light polarizer for converting the unidirectional polarized light received from the transmitter device to the ciphertext;
a polarization value generator for generating the polarization value by to drive the light polarizer in the receiver device using the second sequence of random numbers;
a cipher for decrypting the ciphertext using the first sequence of random numbers generated by the stream generator in the receiver device to recover the plaintext data.

7. The system of claim 6, wherein the first sequence of random numbers is generated by the first stream generator at the transmitter device and by the first stream generator at the receiver device in lock step fashion.

8. The system of claim 6, wherein the second sequence of random numbers is generated by the second stream generator at the transmitter device and by the second stream generator at the receiver device in lock step fashion.

9. The system of claim 6, wherein the number of bits outputted by the first and second stream generators in the transmitter device and the receiver device is configured according to the size of the plaintext data to be transmitted.

10. The system of claim 6, wherein the plaintext data is encrypted and decrypted using an XOR function.

11. A bi-directional communications system, comprising:
(a) a first transmitter device comprising:
a first stream generator for generating a first sequence of random numbers based on a first seed value;
a second stream generator for generating a second sequence of random numbers based on a second seed value;
a light polarizer;
a polarization value generator for generating a polarization value by to drive the light polarizer using the second sequence of random numbers; and
a cipher for encrypting plaintext data received by the first transmitter into ciphertext using the first sequence of random numbers generated by the first stream generator;
wherein the light polarizer converts the ciphertext to unidirectional polarized light for transmission to the receiver device;
(b) a first receiver device comprising:
a first stream generator for generating the first sequence of random numbers based on the first seed value;
a second stream generator for generating the second sequence of random numbers based on the second seed value;
a light polarizer for converting the unidirectional polarized light received from the first transmitter device to the ciphertext;
a polarization value generator for generating the polarization value by to drive the light polarizer in the first receiver device using the second sequence of random numbers;
a cipher for decrypting the ciphertext using the first sequence of random numbers generated by the stream generator in the first receiver device to recover the plaintext data;
(c) a second transmitter device comprising:
a first stream generator for generating a third sequence of random numbers based on a third seed value;
a second stream generator for generating a fourth sequence of random numbers based on a fourth seed value;
a light polarizer;
a polarization value generator for generating a polarization value by to drive the light polarizer in the second transmitter device using the fourth sequence of random numbers; and
a cipher for encrypting plaintext data received by the second transmitter into ciphertext using the third sequence of random numbers generated by the first stream generator in the second transmitter;
wherein the light polarizer converts the ciphertext from the cipher in the second transmitter to unidirectional polarized light for transmission; and
(d) a second receiver device for receiving the unidirectional polarized light from the second transmitter device, comprising:
a first stream generator for generating the third sequence of random numbers based on the third seed value;
a second stream generator for generating the fourth sequence of random numbers based on the fourth seed value;
a light polarizer for converting the unidirectional polarized light received from the second transmitter device to the ciphertext;
a polarization value generator for generating the polarization value by to drive the light polarizer in the second receiver device using the fourth sequence of random numbers;
a cipher for decrypting the ciphertext using the third sequence of random numbers generated by the stream generator in the second receiver device to recover the plaintext data;
wherein the first transmitter device and the second receiver device are cryptographically interlocked and form a first communications unit, and wherein the second transmitter device and the first receiver device are cryptographically interlocked and form a second communications unit.

12. The system of claim 11, wherein first transmitter device and the second receiver device are cryptographically interlocked by combining the output of the first stream generator of the first transmitter device into the output of the first stream generator of the second receiver device.

13. The system of claim 11, wherein second transmitter device and the first receiver device are cryptographically interlocked by combining the output of the first stream generator of the first receiver device into the output of the first stream generator of the second transmitter device.
